(19) United States
(12) Patent Application Publication
(10) Pub. No.: US 2006/0230462 A1
(43) Pub. Date: Oct. 12, 2006

(54) Internet-Based Secure Access Control with Custom Authentication

(75) Inventor: Nagarajan Prabakar, Miami, FL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: THE FLORIDA INTERNATIONAL UNIVERSITY BOARD OF TRUSTEES, Miami, FL (US)

(21) Appl. No.: 10/907,637

(22) Filed: Apr. 8, 2005

(51) Int. Cl. H04L 9/32; H04L 9/00; G06F 17/30; H04K 1/00; G06F 7/04; G06K 9/00; H03M 1/68; H04N 7/16

(52) U.S. Cl. 726/27; 713/182; 713/151; 713/183

(57) ABSTRACT

A method of providing an owner with secure online control of private information comprises providing an owner-editable set of private information. Allowing the owner to edit at least one item of private information and allowing the owner to create a first relationship between a symbolic name and the item of private information. Allowing the owner to create a second relationship between a communication application and the symbolic name. Allowing the owner to create a third relationship between the symbolic name and a client, the third relationship arranged to prevent the client from accessing the item of private information, and providing a website, the website arranged to enable the client to access the symbolic name.

### BACKGROUND

Many online systems attempt to maintain information in a secure and/or private fashion. However, on many such systems the owner of the information cannot conveniently or immediately access the information. Instead, the owner must overcome various protective measures before the owner can gain access to the information. Such protective measures may include keeping the information, such as telephone numbers, account numbers, passwords and/or social security numbers, in a safe location until the information is needed.

For example, an account owner typically needs an account number in order to gain access to his/her own account. The account owner also may wish to allow others to access the account, such as service professionals or other persons or organizations that require access to the owner's account. For example, the owner may grant access to his or her financial planner so that the financial planner can buy/sell stocks, or withdraw, deposit or transfer money. When the account owner reveals the account number and perhaps an associated password to the financial planner, the owner gains the benefit of the financial planner's services. However, the account owner simultaneously gives up absolute control of that account number and the associated password. As such, the account owner may be at risk of intentional or unintentional security risks if, for example, the financial planner has unscrupulous motives, or if the financial planner simply leaves any sensitive information in public view.

While the owner of the sensitive information may, in some circumstances, change a username and password at any time when an apparent breach may have occurred, some sensitive information may not be easily modified. For example, it is a common business practice to require a username for many accounts, such as bank accounts, insurance policies, and health insurance policies. In many circumstances, that username may itself be sensitive information. For example, many financial accounts use the account owner's social security number as the username. Such common business practices often needlessly elevate the account owner's risk of identity theft.

Therefore, owners of sensitive information desire a practical solution to the aforementioned problems that will allow the owner of sensitive information to maintain full control over sensitive information, while still allowing the owner to conveniently access the information in a secure and private fashion.

### SUMMARY

In accordance with an aspect of this invention, a method of providing an owner with secure online control of private information comprises providing an owner-editable set of private information. Allowing the owner to edit at least one item of private information and allowing the owner to create a first relationship between a symbolic name and the item of private information. Allowing the owner to create a second relationship between a communication application and the symbolic name. Allowing the owner to create a third relationship between the symbolic name and a client, the third relationship arranged to prevent the client from accessing the item of private information, and providing a website, the website arranged to enable the client to access the symbolic name.

In further accordance with a preferred embodiment, the method comprises providing a secure socket layer connection for transmitting and receiving the item of private information, and allowing the owner to edit at least one item of private information, including at least one of adding information, deleting information, or modifying information. The owner may create the first relationship of association or disassociation between the symbolic name and the item of private information in which a relationship of association permits a linked reference between the symbolic name and the private information, and a relationship of disassociation disables the linked reference between the symbolic name and the private information.

The owner may create a second relationship of association or disassociation between the communication application and the symbolic name. A relationship of association of the communication application with the symbolic name further permits the communication application to use the symbolic name, while disassociation of the communication application from the symbolic name prevents the communication application from using the symbolic name.

Still preferably, the owner may create a third relationship of association or disassociation between the symbolic name and the client. A relationship of association of the symbolic name with the client permits the client to use the symbolic name, while disassociation of the symbolic name and the client disables the client from using the symbolic name. Permission for the client provides client access to functionality of the communication application.

Additionally, the method further includes the communication application comprising at least one of wireless text messaging, telephone calling, or electronic mail. The owner may create the third relationship which may further include allowing the owner to assign a client name and password to the client, and assign access time limitations on at least one of the client or the symbolic name for client authentication.

Further still, the method provides a website which includes providing a client name, an owner name, or a password field, secure authentication for at least one of the client or the owner with the secure authentication uses at least one of a client name, an owner name or password. The secure authentication may further comprise a secure socket communication layer. The website may, additionally, enable the owner to monitor client activity.

In accordance with another aspect of the invention, a computer readable medium having computer executable instructions for providing an owner with secure online control of private information comprises computer executable instructions for providing an owner-editable set of private information and allowing the owner to edit at least one item of private information. The computer readable medium further comprises allowing the owner to create a first relationship between a symbolic name and the item of private information, allowing the owner to create a second relationship between a communication application and the symbolic name, and allowing the owner to create a third relationship between the symbolic name and a client, the third relationship arranged to prevent the client from accessing the item of private information. The computer readable medium also comprises computer readable instructions for providing a website, the website arranged to enable the client to access the symbolic name.

In accordance with yet another aspect of the invention, a system for providing an owner with secure online control of private information comprises a display unit that is capable of generating video images, an input device, and a processing apparatus operatively coupled to the display unit and the input device, the processing apparatus comprising a processor and a memory operatively coupled to the processor. A network interface connected to a network and to the processing apparatus, the processing apparatus being programmed to provide an owner-editable set of private information, to allow the owner to edit at least one item of private information, and to allow the owner to create a first relationship between a symbolic name and the item of private information. The processing apparatus also allows the owner to create a second relationship between a communication application and the symbolic name, and allows the owner to create a third relationship between the symbolic name and a client, the third relationship arranged to prevent the client from accessing the item of private information. The processing apparatus also being programmed to provide a website, the website arranged to enable the client to access the symbolic name.

In accordance with yet another aspect of the invention, a method of private information control comprises providing an owner with a set of private information, enabling the owner to edit at least one item of private information in the set, enabling the owner to associate a symbolic name and the item of private information, and enabling the owner to associate the symbolic name with a communication application. The method also comprises providing a website arranged to enable the client to access the symbolic name and enables the owner to associate the symbolic name with a client, whereby the client is able to invoke the communication application without access to the item of private information, the communication application rendering services to the client.

### DRAWINGS

FIG. 1 is an exemplary block diagram of a computer system that may operate with a system or method of secure access control with custom authentication.

FIG. 2 is an exemplary block diagram illustrating components of a secure access control system having custom authentication.

FIG. 3 is an exemplary initial owner display screen for use with the system of FIG. 1.

FIG. 4 is an exemplary owner authentication screen for use with the system of FIG. 1.

FIG. 5 is an exemplary task selection screen for use with the system of FIG. 1.

FIG. 6 is an exemplary private information edit screen for use with the system of FIG. 1.

FIG. 7 is an exemplary client information edit screen for use with the system of FIG. 1.

FIG. 8 is an exemplary client event log screen for use with the system of FIG. 1.

FIG. 9 is an exemplary initial client display screen for use with the system of FIG. 1.

FIG. 10 is an exemplary client authentication screen for use with the system of FIG. 1.

FIG. 11 is an exemplary trusted application client screen for use with the system of FIG. 1.

FIG. 12 is an exemplary trusted application results screen for use with the system of FIG. 1.

FIG. 13 is an exemplary client profile screen for use with the system of FIG. 1.

### DESCRIPTION

Although the following text sets forth a detailed description of numerous different embodiments, it should be understood that the legal scope of the invention is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” in conjunction with a function without the recital of any structure, it is not intended that the scope of any claim element be interpreted based on the application of 35 U.S.C. § 112, sixth paragraph.

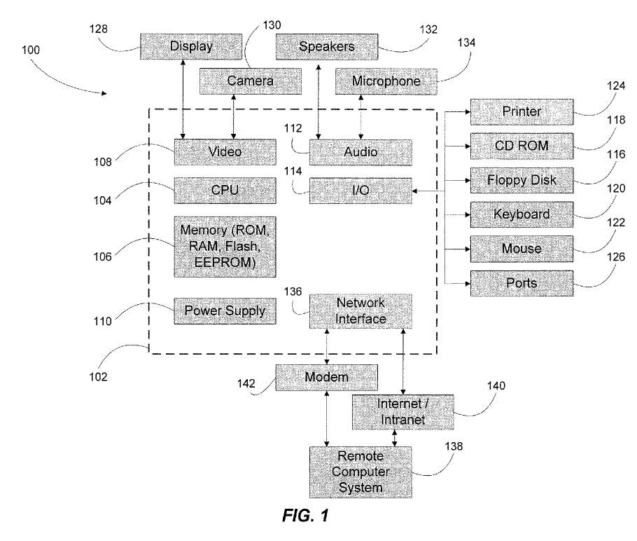

The claimed method and apparatus may be implemented on an exemplary computing system shown in FIG. 1. The system 100 includes functionality similar to well known computing systems including desktop computers, laptop computers, servers, handheld computers, and microprocessor systems, to name a few.

An exemplary computer 102 includes a CPU 104, a memory 106, a video interface 108, a power supply 110, and an audio interface 112. The memory 106 may include several types of computer readable media including ROM, RAM, flash memory, and EEPROM. Such memory may store computer programs, routines, and various data structures. Similarly, an I/O (Input/Output) interface 114 may permit external memory devices, such as floppy disk drives 116 and CDROM drives 118, to store computer programs, routines, and data structures. The I/O interface 114 may also permit; client and owner input via a keyboard 120 and a mouse 122, client and owner output via a printer 124, and bi-directional input/output to/from the computer 102 via various ports 126 (e.g., RS-232, RS-485, parallel, firewire, Bluetooth, etc.). The video interface 108 may support a display 128 and a camera 130, and the audio interface 112 may support speakers 132 and a microphone 134.

A network interface 136 may support remote computer system 138 access via internet and intranet access 140, or permit access to the computer 102 via a modem 142. Additionally, the network interface 136 may support various configurations of local area networks (LAN) and wide area networks (WAN). Furthermore, the network interface 136 may support wired or wireless methods of network connectivity.

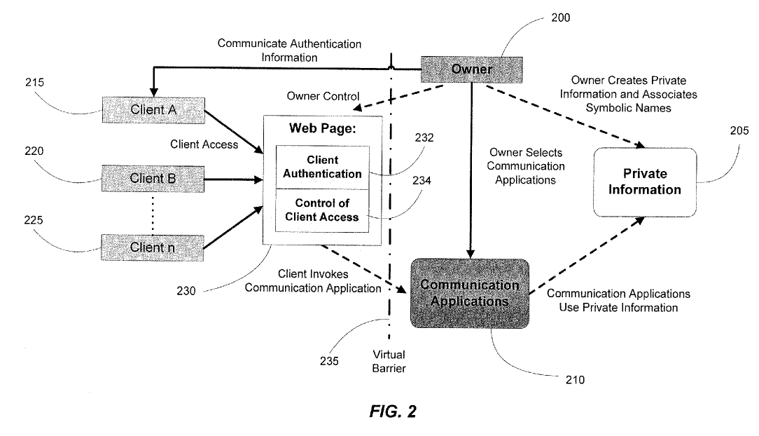

FIG. 2 shows a block diagram for internet based secure access control with custom authentication, in accordance with an example of the present invention. The block diagram may represent functional elements for a system, a method, an apparatus, or a software application directed to internet based secure access control with custom authentication. An owner 200 may create and control a set or item of private information 205. The set may include various items of private information, such as telephone numbers, social security numbers, or any other type of information in which the owner 200 requires privacy. An owner 200 may include, but is not limited to, individuals, groups, and/or organizations. The owner 200 may also create symbolic names to associate with the set or item of private information 205. Such symbolic names may use nomenclature suggesting the content of the private information 205 without explicitly disclosing the details of that information. For example, if the item 205 is a nine-digit social security number, then the owner 200 may create a symbolic name of “SSN,” “Smith SSN,” or “HMO Identification,” to name a few.

An owner 200 may also select a communication application 210 that uses the item 205 to provide some functionality. The communication application 210 may be a software application, a system, or a service provider, to name a few. For example, if the communication application 210 is a wireless telephone application, that application may use a wireless telephone number, i.e., the item of private information 205, to place a call or forward a text message.

The owner 200 may also create a website 230 for clients 215, 220, 225. Alternatively, the system and method may generate a website 230 for clients 215, 220, 225 through various known techniques including Active Server Pages (ASP) and Common Gateway Interface (CGI) scripts. Additionally, the owner 200 may also assign authentication credentials, such as client names and passwords, to particular clients 215, 220, 225. The owner 200 may also assign particular symbolic names to those clients 215, 220, 225. The owner may inform the clients 215, 220, 225 about the website 230 and provide them with the appropriate authentication credentials which will authorize access to the website 230 and permit client access to particular symbolic names.

The clients 215, 220, 225 may access the website 230 by using the assigned authentication credentials. Once authenticated, the website 230 may permit the clients 215, 220, 225 to invoke the services of a particular communication application 210 by using the symbolic name assigned to that particular client 215, 220, 225.

For example, an owner 200, Dr. Smith, may create an item in the form of a wireless telephone number, e.g., 123-4567. She 200 may also create a symbolic name of “Doctor Smith Cell” and associate the wireless telephone number with that symbolic name. Dr. Smith 200 may further select a communication application 210, such as a wireless telephone company text messaging application, to use the item 205, i.e., 123-4567. Additionally, Dr. Smith 200 may create a website 230 for Client B 220, establish authentication credentials for the client 220, assign the symbolic name “Doctor Smith Cell” to him or her 220, and inform the client 220 of the website address and corresponding authentication credentials that will allow the client 220 to log on to the website 230.

Continuing with the example above, Client B 220, perhaps a patient of Dr. Smith 200, may access the website 230 using assigned credentials. The website 230 may present the patient 220 with a list of symbolic names that Dr. Smith 200 has created for the patient's 220 use. The website 230 may also present the patient 220 with a field for entering text messages. The patient's 220 use of the symbolic name “Doctor Smith Cell” and entry of a text message invokes the communication application 210. As a result, a wireless telephone associated with the private telephone number 123-4567 displays the text message entered by the patient 220.

The preceding example illustrates that a virtual barrier 235 prevents any client 215, 220, 225 from accessing or viewing the set or item of private information 205, while simultaneously allowing the authorized client 220 the benefit of the trusted application's 210 functionality. Furthermore, the owner 200 always maintains complete control over the private information 205, the symbolic names, the relationships between the private information 205 and the symbolic names, which communication applications 210 may use the private information 205, client authentication credentials, and which clients 215, 220, 225 may have access to any particular symbolic name. In other words, the owner 200 has complete control over all of the private information 205, and the client 215, 220, 225 has none. Furthermore, the owner 200 controls all aspects of the client's ability to use the system, method, apparatus, or software application for internet based secure access control with custom authentication.

Returning to FIG. 2 in further detail, the owner 200 may control various facets of operation, including managing the set or item of private information 205. The set or item 205 may include any type of information in which the owner 200 desires to remain confidential (i.e., not visible) from all clients 215, 220, 225. Such information 205 may include, but is not limited to, telephone numbers, social security numbers, addresses, account numbers, and passwords. The owner 200 may enter the set or item of private information 205 on a computer or terminal and stored on a computer, server, database, or any other data storage medium, device, or system. Similarly, the owner 200 may delete and edit the items of private information 205, or the whole set of private information 205. All data transfer and storage may occur in a secure manner, particularly when the owner 200 adds, deletes, or edits private information 205 via the website 230. The set or items of private information 205 may be saved to computers, servers, or other storage mediums in an encrypted manner. The data transfer between any combination of client 215, 220, 225, owner 200, and webpage 230 may include a secure socket layer (SSL) connection, thereby helping to ensure data security.

In addition to creating, editing, or deleting private information 205, the owner 200 may manage a relationship between the items of private information 205 and a symbolic name. The symbolic name, generated by the owner 200, may include alphanumeric text and may further describe the private information 205 in a general manner. For example, if the item 205 is a social security number having nine digits, the symbolic name may be “SSN,” “Smith SSN,” or “HMO ID” to name a few. If the owner 200 creates a relationship of association between the symbolic name and the private information 205, then any further use of this symbolic name, discussed in further detail below, will reference the nine-digit social security number, but will not explicitly disclose or publicize that number to the client 215, 220, 225. In other words, the item of private information 205 is invisible to the client 215, 220, 225 using the symbolic name, thereby protecting the owner 200 from theft, misuse, or accidental disclosure of the item 205. On the other hand, if the owner 200 no longer wants the association between the symbolic name and the item 205, the owner 200 may disassociate the relationship. Each item of private information 205 may be associated or disassociated with a unique symbolic name. Alternatively, one symbolic name may be associated or disassociated with several pieces of private information 205, i.e., the set of private information.

FIG. 2 also illustrates a communication application 210. The owner 200 may select one or more communication applications 210 that utilize the private information 205. As discussed earlier, the communication application 210 may be a software application, a system, or a service provider. Generally speaking, the communication application 210 may be any service which uses items of private information 205, or requires such items prior to executing services offered by the communication application 210. In the preceding example, a wireless telephone messaging service was the communication application 210 requiring the wireless telephone number and the text message prior to rendering service. In that example, the owner 200 of the wireless telephone number gained the benefit of allowing clients 215, 220, 225 to utilize that number without concern of the number being abused or distributed to others. In that regard, if at any time the owner 200 decides that the client 215, 220, 225 should no longer have access to the services rendered by the communication application 210, the owner 200 may simply disassociate that communication application 210 from the set or item of private information 205. One way in which the owner may prevent client 215, 220, 225 access is to comment-out or delete the client's 215, 220, 225 authentication credentials, as will be described in more detail later. A second way in which the owner may prevent a client from using the system is to modify or disassociate the client information from the list of symbolic names, also discussed later. Alternatively, if the owner 200 decides that the client 215, 220, 225 should only have access to the symbolic name for a specific period of time, then the owner 200 may further associate dates and times for which the client's use of the symbolic name will invoke the communication application 210. For example, if the owner 200 is a doctor and the patient is the client 215, 220, 225 participating in a clinical trial lasting three months, then the doctor 200 may establish a three month time limitation for which the patient's use of the symbolic name results in sending a text message to the doctor 200. Furthermore, the doctor 200 may establish a range of times throughout the day for which any use of the symbolic name will permit invocation of the communication application 210.

Additionally, if the owner 200 chooses a different communication application 210, e.g., a competing wireless provider, the owner 200 may simply associate the new application 210 (e.g., new wireless provider) with the item of private information while simultaneously disassociating the former communication application 210 (e.g., old wireless provider). As such, the clients 215, 220, 225 have no burden of a new or alternate symbolic name to use for receiving the services rendered by the new communication application 210. In fact, the clients 215, 220, 225 may not even know that the communication application 210 has changed at all.

Wireless telephone messaging systems, however, illustrate only one embodiment which uses a system and method of internet based secure access control with custom authentication. Additional applications may include, but are not limited to; electronic mail systems allowing an owner the ability to receive e-mail without disclosing the e-mail address, telephone systems allowing an owner to receive calls without disclosing the telephone number, home automation access, home appliance access, security system access, software licensing applications, and financial and medical account access. As an additional example, if a patient has a medical insurance plan for which the insurance company uses the patient's social security number as an identification number, the patient is typically obligated to disclose that social security number to a health care provider (e.g., doctor's office staff) prior to receiving care and treatment. Unfortunately, the patient typically has no control of the social security number after disclosing it to the health care provider. If the health care provider neglects to shred documents, the patient may be at a much greater risk of identity theft. Alternatively, the patient (i.e., owner 200) may provide the health care provider (i.e., client 215, 220, or 225) with a web address, authentication credentials, and a symbolic name (e.g., “Smith HMO ID”). When the health care provider 215, 220, 225 uses the symbolic name, the communication application 210 receives the associated social security number and may validate that number with an HMO member database. The communication application 210 may further return a simple “approve” or “disapprove” status indication to the health care provider 215, 220, 225, or any similar innocuous indication of valid health insurance coverage without subjecting the patient's 200 social security number 205 to unnecessary publication.

FIG. 2 also illustrates a web page 230 which, among other functions, enables the owner 200 to manage authentication credentials (Client Authentication module 232) for one or more clients 215, 220, 225. The owner 200 may create, modify, and delete client names and passwords for the clients 215, 220, 225. The web page 230 also includes a Control of Client Access module 234 which, as discussed earlier, allows the owner 200 to associate and disassociate symbolic names with/from the clients 215, 220, 225.

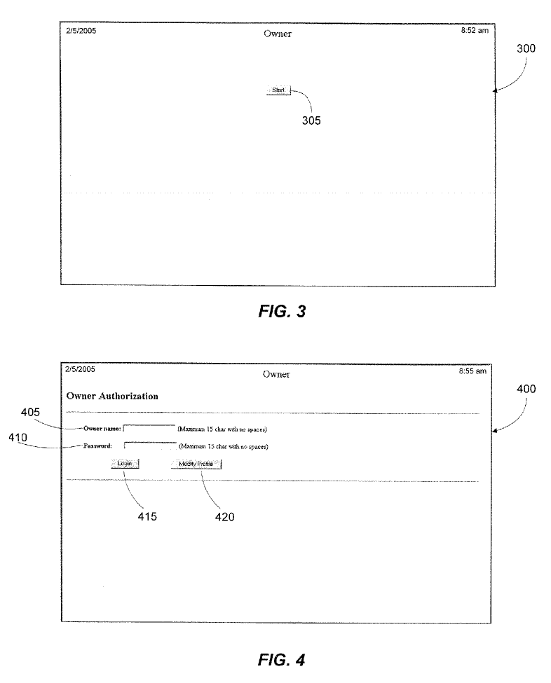

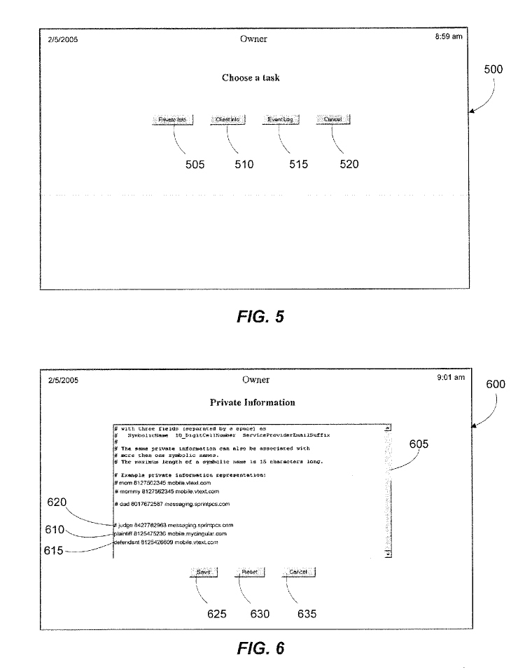

FIG. 3 illustrates an exemplary initial screen 300 for the owner 200 including a welcome screen and Start button 305. After selecting the Start button 305, an Owner Authorization screen 400 may appear, shown in FIG. 4, including an owner name field 405 and a password field 410. The system and method for internet based secure access control with custom authentication may accommodate more than one owner 200, with each owner 200 having a seperate account. When the owner 200 provides an owner name, a corresponding password, and selects a Login button 415, the owner 200 thereafter gains access to the account and views a screen similar to the one shown in FIG. 5. Alternatively, the owner's 200 selection of a Modify Profile button 420, assuming entry of appropriate authorization credentials, may permit the owner to modify the assigned password for future access.

A Task Page 500 includes a Private Information button 505, a Client Information button 510, an Event Log button 515, and a Cancel button 520. The Task Page 500 allows the owner 200 to manage the account by further managing the set or item of private information 205 and corresponding symbolic names, managing the client information (i.e., by modifying the client authentication credentials and/or modifying the symbolic names associated with the client) and corresponding authentication credentials, and an event log to track client activity.

Selection of the Private Information button 505 may result in a Private Information screen 600, as shown in FIG. 6. A data entry field 605 permits the owner 200 to review instructions, record comments, and manage relationships between items of private information 205 and symbolic names. The data entry field 605 includes a number sign (i.e., “#”) to distinguish notes or comments from items that are actively associated with a symbolic name. The embodiment shown in FIG. 6 illustrates that a row may include three fields, each separated by a space. The first field is the symbolic name, the second field is the private information 205, and the third field is a functional suffix for the private information 205 as required by the exemplary communication application 210 (i.e., wireless telephone service provider). Of course, FIG. 6 is merely an exemplary embodiment and, as such, the Private Information screen 600 and private information field configuration may incorporate any design according to the needs of any communication application 210.

FIG. 6 also illustrates a private information row 610 including a symbolic name “plaintiff” (first field), an item of private information “8125475236” 205 (second field), and a suffix “mobile.mycingular.com” (third field). FIG. 6 also illustrates a second associated private information row 615 with a symbolic name “defendant” (first field), an item of private information “8125426609” 205 (second field), and a suffix “mobile.vtext.com” (third field). The absence of the comment symbol for the last two private information rows, 610 and 615, illustrate that both symbolic names “plaintiff” and “defendant” are associated with private information 205. On the other hand, private information row 620 includes the comment symbol (“#”), thereby disassociating the symbolic name “judge” from the item 205 “8427782963.” The owner 200 may simply edit the data entry field 605 whenever an item of private information 205 needs addition, modification, association with, or disassociation from a symbolic name.

When the owner 200 is finished managing the private information 205, selecting a Save button 625 may save any changes. Alternatively, selecting a Reset button 630 may discard all current and previously saved changes and place default information in the data entry field, and selecting a Cancel button 635 disregards any recent modifications made within the data entry field 605.

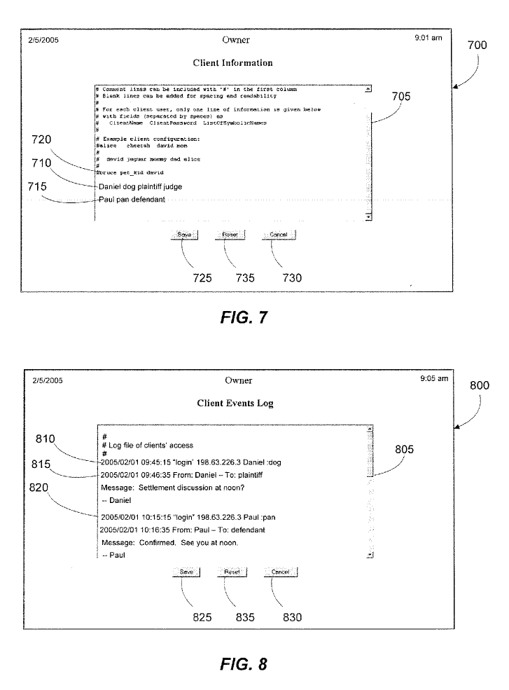

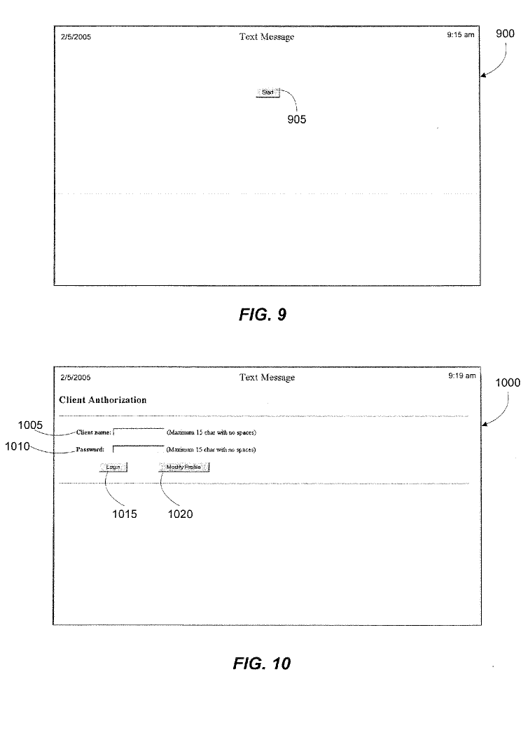

Returning to FIG. 5, selection of the Client Information button 510 may result in a Client Information screen 700, as shown in FIG. 7. Much like FIG. 6, FIG. 7 includes a data entry field 705 and permits the owner 200 to review instructions, record comments, and manage client authentication credentials. Furthermore, the owner 200 may manage which symbolic names a particular client 215, 220, 225 may access and use. The embodiment shown in FIG. 7 illustrates that a row may include multiple fields, each field separated by a space. The first field is a client name, the second field is a password for the client name, and the third field, and any additional fields thereafter, are symbolic names for which the client 215, 220, 225 may access and use.

FIG. 7 illustrates a client information row 710 including a client name “Daniel” (first field), a password “dog” (second field), and two symbolic names “plaintiff” and “judge” (third and fourth fields, respectively). Client information row 710 allows a client 215, 220, 225 with authentication credentials of client name “Daniel” and password “dog” to access the system and method for internet based secure access control with custom authentication. Furthermore, client information row 710 allows the authenticated client 215, 220, 225 access to the symbolic names “plaintiff” and “judge.” In much the same way, client information row 715 allows a client 215, 220, 225 with authentication credentials of client name “Paul” and password “pan” to access the symbolic name “defendant.” Comment symbols (“#”) in front of any client information row may disable client authentication credentials and any associated symbolic names for that client, as is shown by client information row 720. The client name “bruce” no longer has access to the system and method for internet based secure access control with custom authentication, much less any access to a symbolic name “david.” Note that despite the client information row 710 showing that client “Daniel” has access to the symbolic name “judge,” the client “Daniel” will not have access to any services related to that symbolic name because the information row 620 on the Private Information screen 600 includes a comment symbol (“#”).

When the owner 200 is finished managing the client information, selecting a Save button 725 may save any changes, and selecting a Cancel button 730 may disregard any recent modifications made within the data entry field 705. Alternatively, selecting a Reset button 735 may discard all current and previously saved changes and place default information in the data entry field 705.

Returning again to FIG. 5, selection of the Event Log button 515 may result in an Event Log screen 800, as shown in FIG. 8. A data display and entry field 805 permits the owner 200 to review activity of all clients 215, 220, 225 for which the owner has granted authorization credentials. Event log information row 810 illustrates that the client named “Daniel” used the password “dog” to login to the system and method for internet based secure access control with custom authentication. The information row 810 also shows the access date of Feb. 1, 2005 at 9:45 a.m. Event log information row 815 illustrates that the “Daniel” client sent a message using the symbolic name “plaintiff” at 9:46 a.m. having text “Settlement discussion at noon?” Similarly, event log information row 820 illustrates login and activity information for the client named “Paul.”

In addition to reporting client activity, the owner 200 may also manually enter information in the data display and entry field 805. Upon completion, the owner 200 may select a Save button 825 to save such manual data entries. Alternatively, if the owner 200 does not make any manual entries, or if the owner 200 chooses not to save such manual entries, the owner 200 may select a Cancel button 830 to exit the Event Log web page 800. Furthermore, the owner 200 may select a Reset button 835 to clear the event log information.

Briefly returning to FIG. 5, selection of the Cancel button 520 may result in presentation of the Owner Authorization screen as shown in FIG. 4. The Cancel button 520 may also prevent further access to the system or method until an owner 200 provides appropriate authentication credentials.

Returning again to FIG. 2, the owner 200 may inform various clients 215, 220, 225 about authentication credentials and the web address which allow those clients 215, 220, 225 to access the system and method. The clients 215, 220, 225, after entering the appropriate web address on an internet browser, may access a Text Message screen 900 including welcome information, basic instructions, or a Start button 905. Selection of the Start button 905 results in a Client Authorization screen 1000, as shown in FIG. 10. After a client 215, 220, 225 enters valid credentials in a client name field 1005 and a password field 1010, such as those credentials established by the owner 200 on the Client Information screen 700, and selects a Login button 1015, a Message Entry screen 1100 may appear, as shown in FIG. 11. Assuming from the previous example that “Daniel” is the client 215, 220, 225, the Message Entry screen 1100 may include the symbolic names previously authorized by the owner 200. In particular, referring again to the example illustrated in FIG. 7, the owner 200 authorized client “Daniel” to use symbolic names “plaintiff” and “judge.” As shown in FIG. 11, a Recipient drop-down box 1105 shows the first of two symbolic names for which client “Daniel” has authorization to use. Selection of the Recipient drop-down box 1105 may further result in a list of all symbolic names for which that particular client 215, 220, 225 has authorization to use.

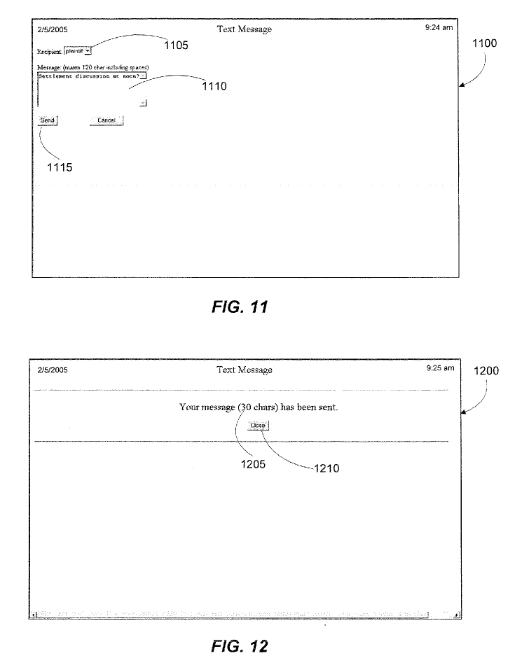

Message entry field 1110 allows the client 215, 220, 225 to enter alphanumeric data. The length of the data may be limited according to restrictions associated with the communication application 210. Alternatively, the owner 200 may establish custom message data length limitations with an option or configuration set-up screen (not shown). Selection of a Send button 1115 may result in a transfer of the contents of the message entry field 1110 to the communication application 210 that is associated with the symbolic name selected by the client 215, 220, 225. Additionally, selection of the Send button 1115 may also present the client 215, 220, 225 with a Send Confirmation screen 1200, as shown in FIG. 12. The Send Confirmation screen 1200 may also display additional information about the message data, such as the number of characters sent 1205. Selection of the Close button 1210 may display the Client Authorization screen 1000.

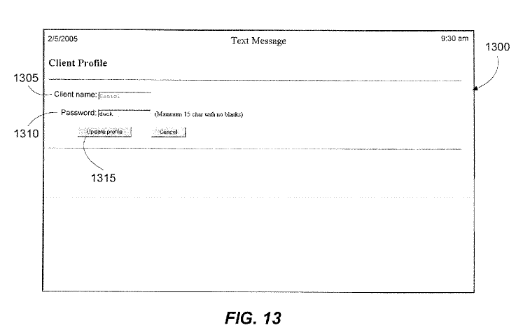

The Client Authorization screen 1000 may also allow the client 215, 220, 225 to modify various parameters of a client profile. The client's selection of a Modify Profile button 1020, assuming entry of appropriate authorization credentials (in the client name field 1005 and the password field 1010), may display a Client Profile screen 1300, as shown in FIG. 13. A client name field 1305 is disabled to prevent client modification, but a password field 1310 may allow the client 215, 220, 225 to enter an alternative password for future access. Changes made to the password may appear in the Client Information screen 700. Additionally, such administrative changes may also appear in the client events log 800. FIG. 13 shows client changes to the contents of the password field 1310 from “dog” to “duck.” Selection of an Update Profile button 1315 may update the client password accordingly, and then display a confirmation message or again display the Client Authorization screen 1000.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

What is claimed as new and desired to be protected by Letters Patent of the United States is:

1. A method of providing an owner with secure online control of private information comprising:
providing an owner-editable set of private information;
allowing the owner to edit at least one item of private information;
allowing the owner to create a first relationship between a symbolic name and the item of private information;
allowing the owner to create a second relationship between a communication application and the symbolic name;
allowing the owner to create a third relationship between the symbolic name and a client, the third relationship arranged to prevent the client from accessing the item of private information; and
providing a website, the website arranged to enable the client to access the symbolic name.

2. The method of claim 1, wherein providing the owner-editable set of private information comprises providing a secure socket layer connection for transmitting and receiving the item of private information.

3. The method of claim 1, wherein allowing the owner to edit at least one item of private information includes at least one of adding information, deleting information, or modifying information.

4. The method of claim 1, wherein allowing the owner to create a first relationship includes a relationship of association or disassociation between the symbolic name and the item of private information.

5. The method of claim 4, wherein association of the symbolic name with the private information permits a linked reference between the symbolic name and the private information, and wherein disassociation of the symbolic name from the private information disables the linked reference between the symbolic name and the private information.

6. The method of claim 1, wherein allowing the owner to create a second relationship includes a relationship of association or disassociation between the communication application and the symbolic name.

7. The method of claim 6, wherein association of the communication application with the symbolic name further permits the communication application to use the symbolic name, and wherein disassociation of the communication application from the symbolic name prevents the communication application from using the symbolic name.

8. The method of claim 1, wherein allowing the owner to create a third relationship includes a relationship of association or disassociation between the symbolic name and the client.

9. The method of claim 8, wherein association of the symbolic name with the client permits the client to use the symbolic name, and wherein disassociation of the symbolic name and the client disables the client from using the symbolic name.

10. The method of claim 9, wherein permission for the client to use the symbolic name further comprises providing client access to functionality of the communication application.

11. The method of claim 1, wherein allowing the owner to create the second relationship further includes the communication application comprising at least one of wireless text messaging, telephone calling, or electronic mail.

12. The method of claim 1, wherein allowing the owner to create the third relationship further includes allowing the owner to assign a client name and password to the client for client authentication.

13. The method of claim 1, wherein allowing the owner to create a third relationship further includes allowing the owner to assign access time limitations on at least one of the client or the symbolic name.

14. The method of claim 1, wherein providing a website further includes providing a client name, an owner name, or a password field.

15. The method of claim 1, wherein providing a website further includes providing secure authentication for at least one of the client or the owner.

16. The method of claim 15, wherein the secure authentication further comprises using at least one of a client name, an owner name, or a password.

17. The method of claim 15, wherein providing secure authentication further comprises a secure socket communication layer.

18. The method of claim 1, wherein providing the website further comprises the website arranged to enable the owner to monitor client activity.

19. A computer readable medium having computer executable instructions for providing an owner with secure online control of private information comprising:
computer executable instructions for providing an owner-editable set of private information;
computer executable instructions for allowing the owner to edit at least one item of private information;
computer executable instructions for allowing the owner to create a first relationship between a symbolic name and the item of private information;
computer executable instructions for allowing the owner to create a second relationship between a communication application and the symbolic name;
computer executable instructions for allowing the owner to create a third relationship between the symbolic name and a client, the third relationship arranged to prevent the client from accessing the item of private information; and
computer executable instructions for providing a website, the website arranged to enable the client to access the symbolic name.

20. The computer readable medium of claim 19, wherein providing the owner-editable set of private information comprises providing a secure socket layer connection for transmitting and receiving the item of private information.

21. The computer readable medium of claim 19, wherein allowing the owner to edit at least one item of private information includes at least one of adding information, deleting information, or modifying information.

22. The computer readable medium of claim 19, wherein allowing the owner to create a first relationship includes a relationship of association or disassociation between the symbolic name and the item of private information.

23. The computer readable medium of claim 22, wherein association of the symbolic name with the private information permits a linked reference between the symbolic name and the private information, and wherein disassociation of the symbolic name from the private information disables the linked reference between the symbolic name and the private information.

24. The computer readable medium of claim 19, wherein allowing the owner to create a second relationship includes a relationship of association or disassociation between the communication application and the symbolic name.

25. The computer readable medium of claim 24, wherein association of the communication application with the symbolic name further permits the communication application to use the symbolic name, and wherein disassociation of the communication application from the symbolic name prevents the communication application from using the symbolic name.

26. The computer readable medium of claim 19, wherein allowing the owner to create a third relationship includes a relationship of association or disassociation between the symbolic name and the client.

27. The computer readable medium of claim 26, wherein association of the symbolic name with the client permits the client to use the symbolic name, and wherein disassociation of the symbolic name and the client disables the client from using the symbolic name.

28. The computer readable medium of claim 27, wherein permission for the client to use the symbolic name further comprises providing client access to functionality of the communication application.

29. The computer readable medium of claim 19, wherein allowing the owner to create the second relationship further includes the communication application comprising at least one of wireless text messaging, telephone calling, or electronic mail.

30. The computer readable medium of claim 19, wherein allowing the owner to create the third relationship further includes allowing the owner to assign a client name and password to the client for client authentication.

31. The computer readable medium of claim 19, wherein allowing the owner to create a third relationship further includes allowing the owner to assign access time limitations on at least one of the client or the symbolic name.

32. The computer readable medium of claim 19, wherein providing a website further includes providing a client name, an owner name, or a password field.

33. The computer readable medium of claim 19, wherein providing a website further includes providing secure authentication for at least one of the client or the owner.

34. The computer readable medium of claim 33, wherein the secure authentication further comprises using at least one of a client name, an owner name, or a password.

35. The computer readable medium of claim 33, wherein providing secure authentication further comprises a secure socket communication layer.

36. The computer readable medium of claim 19, wherein providing the website further comprises the website arranged to enable the owner to monitor client activity.

37. A system for providing an owner with secure online control of private information comprising:
a display unit that is capable of generating video images;
an input device;
a processing apparatus operatively coupled to the display unit and the input device, the processing apparatus comprising a processor and a memory operatively coupled to the processor;
a network interface connected to a network and to the processing apparatus;
the processing apparatus being programmed to provide an owner-editable set of private information;
the processing apparatus being programmed to allow the owner to edit at least one item of private information;
the processing apparatus being programmed to allow the owner to create a first relationship between a symbolic name and the item of private information;
the processing apparatus being programmed to allow the owner to create a second relationship between a communication application and the symbolic name;
the processing apparatus being programmed to allow the owner to create a third relationship between the symbolic name and a client, the third relationship arranged to prevent the client from accessing the item of private information; and
the processing apparatus being programmed to provide a website, the website arranged to enable the client to access the symbolic name.

38. The system of claim 37, wherein providing the owner-editable set of private information comprises providing a secure socket layer connection for transmitting and receiving the item of private information.

39. The system of claim 37, wherein allowing the owner to edit at least one item of private information includes at least one of adding information, deleting information, or modifying information.

40. The system of claim 37, wherein allowing the owner to create a first relationship includes a relationship of association or disassociation between the symbolic name and the item of private information.

41. The system of claim 40, wherein association of the symbolic name with the private information permits a linked reference between the symbolic name and the private information, and wherein disassociation of the symbolic name from the private information disables the linked reference between the symbolic name and the private information.

42. The system of claim 37, wherein allowing the owner to create a second relationship includes a relationship of association or disassociation between the communication application and the symbolic name.

43. The system of claim 42, wherein association of the communication application with the symbolic name further permits the communication application to use the symbolic name, and wherein disassociation of the communication application from the symbolic name prevents the communication application from using the symbolic name.

44. The system of claim 37, wherein allowing the owner to create a third relationship includes a relationship of association or disassociation between the symbolic name and the client.

45. The system of claim 44, wherein association of the symbolic name with the client permits the client to use the symbolic name, and wherein disassociation of the symbolic name and the client disables the client from using the symbolic name.

46. The system of claim 45, wherein permission for the client to use the symbolic name further comprises providing client access to functionality of the communication application.

47. The system of claim 37, wherein allowing the owner to create the second relationship further includes the communication application comprising at least one of wireless text messaging, telephone calling, or electronic mail.

48. The system of claim 37, wherein allowing the owner to create the third relationship further includes allowing the owner to assign a client name and password to the client for client authentication.

49. The system of claim 37, wherein allowing the owner to create a third relationship further includes allowing the owner to assign access time limitations on at least one of the client or the symbolic name.

50. The system of claim 37, wherein providing a website further includes providing a client name, an owner name, or a password field.

51. The system of claim 37, wherein providing a website further includes providing secure authentication for at least one of the client or the owner.

52. The system of claim 51, wherein the secure authentication further comprises using at least one of a client name, an owner name, or a password.

53. The system of claim 51, wherein providing secure authentication further comprises a secure socket communication layer.

54. The system of claim 37, wherein providing the website further comprises the website arranged to enable the owner to monitor client activity.

55. A method of private information control comprising:
providing an owner with a set of private information;
enabling the owner to edit at least one item of private information in the set;
enabling the owner to associate a symbolic name and the item of private information;
enabling the owner to associate the symbolic name with a communication application;
providing a website arranged to enable the client to access the symbolic name; and
enabling the owner to associate the symbolic name with a client, whereby the client is able to invoke the communication application without access to the item of private information, the communication application rendering services to the client.

56. The method of claim 55, wherein enabling the owner to edit includes at least one of adding information, deleting information, or modifying information.

57. The method of claim 55, wherein invoking the communication application includes at least one of text messaging, telephone calling, or electronic mail.
